(19) United States
(12) Patent Application Publication
(10) Pub. No.: US 2012/0209657 A1
(43) Pub. Date: Aug. 16, 2012

(54) LOCATION TRIGGERED SERVICE RESPONSE

(76) Inventor: Aladdin Connolly, Shrewsbury, MA (US)

(21) Appl. No.: 13/371,754

(22) Filed: Feb. 13, 2012

Related U.S. Application Data
(60) Provisional application No. 61/442,330, filed on Feb. 14, 2011.

(51) Int. Cl. G06Q 30/06; G06Q 10/00; G06Q 20/32

(52) U.S. Cl. 705/7.29; 705/26.1; 705/26.7; 705/26.5

(57) ABSTRACT

An automated location based customer detection and ordering system determines proximity of a customer to a merchant and initiates an ordering mechanism for common routine purchases. Purchases such as coffee, bagels, donuts and other food and snack items are often readily available to a mobile customer from a variety of retail establishments of various merchants. A personal electronic device such as a cellphone or smartphone corresponds to the user and indicates the user's presence within proximity of a particular merchant. A user is registered with various merchants, typically retail service locations, for a particular predetermined service offering from available menu items. A central repository or clearinghouse receives the proximity indication of a user and a registered merchant, and sends a confirmation request for the predetermined service offering. Upon user confirmation or order modification, the clearinghouse sends a confirmed order request to the merchant for preparation and delivery on user arrival.

### CROSS REFERENCE TO EARLIER FILED PATENT APPLICATIONS

This application claims the benefit under 35 U.S. C. §119(e) of the filing date of the following earlier filed co-pending U.S. Provisional Patent Application Ser. No. 61/442,330, entitled “LOCATION TRIGGERED SERVICE RESPONSE”, having Attorney Docket CLY11-01p, filed on Feb. 14, 2011.

### BACKGROUND

Businesses have a financial interest in improving efficiency, customer experience, client loyalty, comprehensive customer data acquisition, and risk reduction. In the retail services industry, for example, much business volume is generated from relatively low cost transactions for food and beverage items (i.e. coffee, donuts, burgers, etc.). Retail service establishments offering a hybrid goods and services product such as prepared foods and beverages, often rely on passerby convenience as a means of attracting customers. Further, such retail goods and services are often available via drive-through locations, contributing both an impulse-buy mentality as well as a likelihood of generally available alternatives nearby, as retail establishments tend to cluster in high traffic areas. As these types of discretionary purchases are often undertaken via counter or drive through service at establishments that rely on high volume, a line or queue often forms at times of peak demand.

### SUMMARY

An automated location based customer detection and ordering system determines proximity of a customer to a merchant and initiates an ordering mechanism for common routine purchases. Purchases such as coffee, bagels, donuts and other food and snack items are often readily available to a mobile customer from a variety of retail establishments of various merchants. A personal electronic device such as a cellphone or smartphone corresponds to the user and indicates the user's presence within proximity of a particular merchant. A user is registered with various merchants, typically retail service locations, for a particular predetermined service offering from available menu items. A central repository or clearinghouse receives the proximity indication of a user and a registered merchant, and sends a confirmation request to the user device for the predetermined service offering. Upon user confirmation or order modification, the clearinghouse sends a confirmed order request to the merchant for preparation and delivery on user arrival. For a business that has a large number of repeat customers, and who often replicate the same or similar orders, a method for identifying the customer and the order without needing to use a so-called “squawk box” common at drive through establishments saves time and reduces errors. Automated financial transactions using stored tokens or identifiers further provide additional time savings because the business is relieved of handling payments related to the transaction.

Configurations herein are based, in part, on the observation that many customers often purchase the same or similar items from a particular merchant (vendor) on successive occasions. A pattern often emerges of frequently ordering the same item and/or stopping at the same vendor or location on a regular basis. For example, a customer routinely stops for a coffee and a bagel at a particular store on weekday mornings, or typically stops for coffee at around 3:00 at a particular vendor, wherever they happen to be.

Unfortunately, conventional approaches to menu based ordering suffer from a shortcoming of repetitive ordering of the same or similar items due to consistently waiting for preparation of the item. Additionally, customer volume at peak hours further extends the waiting time in line for ordering and for delivery of the item once ordered. Accordingly, configurations herein substantially overcome the above-described shortcomings of conventional ordering of such routine purchases, particularly from a service based merchant that must prepare the purchased item, such as a food or beverage offering, by providing a location triggered service response to identify proximity of a customer to a merchant, confirm a request for the routine order, and commence preparation prior to customer arrival so that the item is prepared for receipt when the customer arrives.

Retail service establishments such as those catering to a large drive-through window customer base often encounter repeat customers as well as cyclic demand that tends to be prone to high-volume peaks (i.e. rush hour) when quick turnaround is particularly significant. Configurations herein disclose a computer implemented method, wherein a prearranged transaction is initiated by a mobile device with GPS (Global Positioning System) location tracking capabilities based upon a GPS position determination. During the busiest times at these locations the speed at which a customer (subscriber) is served directly affects sales, as well as the customer experience. Many potential customers, who would purchase from the business, may see the line length and determine that they are not willing to wait the necessary time to get served.

Configurations discussed further below describe a method of providing services responsive to proximity of a customer to the service provider or merchant by identifying a set of service providers having service selections, and storing the identified set in a repository, such that the repository is responsive to geographic location signals indicative of a subscriber location. The centralized repository and associated server determine when a subscriber is in proximity to an identified service provider, and informs the service provider of the presence and identity of the proximate subscriber. The centralized server retrieves, based on the identity, a preferred one of the service selections of the proximate subscriber.

Determining customer (subscriber) proximity further includes determining when a computing module (i.e. GPS/WiFi/WiMax phone) of a subscriber is in proximity to a service provider responsive to a geographic location. The computing module is typically a mobile personal computing device responsive to wireless signals for Internet connectivity. In the example arrangement, the geographic location signals are generated by a GPS responsive device, however other location sensitive mechanisms may be employed. Service selection involves a Graphical User Interface (GUI) of the computing module for storing, associated with the subscriber, a preferred service selection of the service provider. In the example arrangement, proximity is determined by the computing module of the subscriber being disposed within a predetermined distance from a mobile service provisioning station (i.e. drive-thru).

Users (customers) install the application (app) on their user device and enter a standard transaction that they repeat on a regular basis. (Examples would include a repeatable order at a favorite drive-through coffee shop, car wash, oil change location, or a drive-through pharmacy medical prescription.). At the time the user installs the app, they would be able to choose from a list of businesses currently participating in the service. Remote updates add businesses as they become available. The user's payment information such as bank or credit card data would also be entered at the time of app installation.

When the user device is within a pre-set distance of the geographic location of the participating business, the user device would alert the user to several options, including but not limited to, ignoring the alert, placing a standard order, or alternately changing their order (if that option is chosen, a list of options such as the menu in the case of food establishments would be listed). When the user accepts the order option, the payment is made automatically through the user's payment option on file. The customer's name and order would show on the screen of a computer or other telecommunication device in the business establishment.

In further detail, configurations disclosed herein provide a method for ordering services by determining, based on a location, that a customer is proximate to a merchant, and identifying, based on an identity of the customer, a predetermined offering of the merchant for preparation. A central server or clearinghouse sends an indication to the customer indicative of the predetermined offering, and receives an order confirmation from the customer indicating acceptance of the order. The clearinghouse then sends the order to the merchant for the predetermined offering, based on the order confirmation, on behalf of the customer for customer pickup upon arrival.

Alternate configurations of the invention include a multiprogramming or multiprocessing computerized device such as a multiprocessor, controller or dedicated computing device in either a handheld, mobile, or desktop form or the like configured with software and/or circuitry (e.g., a processor as summarized above) to process any or all of the method operations disclosed herein as embodiments of the invention. Still other embodiments of the invention include software programs such as a Java Virtual Machine and/or an operating system that can operate alone or in conjunction with each other with a multiprocessing computerized device to perform the method embodiment steps and operations summarized above and disclosed in detail below. One such embodiment comprises a computer program product that has a non-transitory computer-readable storage medium including computer program logic encoded as instructions thereon that, when performed in a multiprocessing computerized device having a coupling of a memory and a processor, programs the processor to perform the operations disclosed herein as embodiments of the invention to carry out data access requests. Such arrangements of the invention are typically provided as software, code and/or other data (e.g., data structures) arranged or encoded on a computer readable medium such as an optical medium (e.g., CD-ROM), floppy or hard disk or other medium such as firmware or microcode in one or more ROM, RAM or PROM chips, field programmable gate arrays (FPGAs) or as an Application Specific Integrated Circuit (ASIC). The software or firmware or other such configurations can be installed onto the computerized device (e.g., during operating system execution or during environment installation) to cause the computerized device to perform the techniques explained herein as embodiments of the invention.

### BRIEF DESCRIPTION OF THE DRAWINGS

The foregoing will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles disclosed herein.

FIG. 1 shows a services environment suitable for use with configurations herein;.

FIG. 2 is a flowchart of service ordering in the environment of FIG. 1;

FIG. 3 is a block diagram of the ordering sequence as in FIG. 2; and

FIGS. 4-6 are a flowchart of the ordering sequence of FIG. 3.

### DETAILED DESCRIPTION

The disclosed configuration utilizes computing devices through software on general purpose computing devices such as hand held phones and the like. Configurations disclosed below depict examples of customer (user) usage of a mobile device in conjunction with an application for communication with a central server or clearinghouse for detecting proximity, confirming the order, and transmitting the order to the merchant or vendor site providing the service. Many personal electronic devices such as cellphones, smartphones, tablets, readers and other mobile devices are equipped with GPS (Global Positioning System) capability for transmitting a signal indicative of the customer's location to the clearinghouse for proximity based ordering as disclosed herein.

The disclosed approach offers significant advantages to drive-through retail establishments. Such businesses are used as exemplary but should not be considered the only potential applications. Businesses have a financial interest in improving efficiency, customer experience, client loyalty, comprehensive customer data acquisition, and risk reduction. These configurations offer all these advantages as well as the ability to improve customer reward programs in ways unique to the available data for the business.

During the busiest times at these locations the speed at which a customer is served directly affects sales, as well as the customer experience. Many potential customers, who would purchase from the business, see the line length and determine that they are not willing to wait the necessary time to get served.

Customer experience is enhanced by being able to acquire the desired items with no interaction except a friendly greeting and being handed what you want is the ideal experience for a customer. Not having to deal with ordering or carrying cash or even paying is the embodiment of a great customer experience.

Configurations herein therefore enhance client loyalty. Every business covets strong client loyalty. Brand ambassadors are the best form of advertisement. Tailoring a strong rewards system to the unique preferences of each client, and especially rewarding clients for brand evangelizing are key aspects of brand loyalty. The depth of the customer data that can be acquired is a significant advantage for the business. Further, customer loyalty and rewards programs, which are becoming increasingly popular with many retail entities, can also easily track the automated service response and accumulate the purchases made by a particular customer for loyalty based incentives.

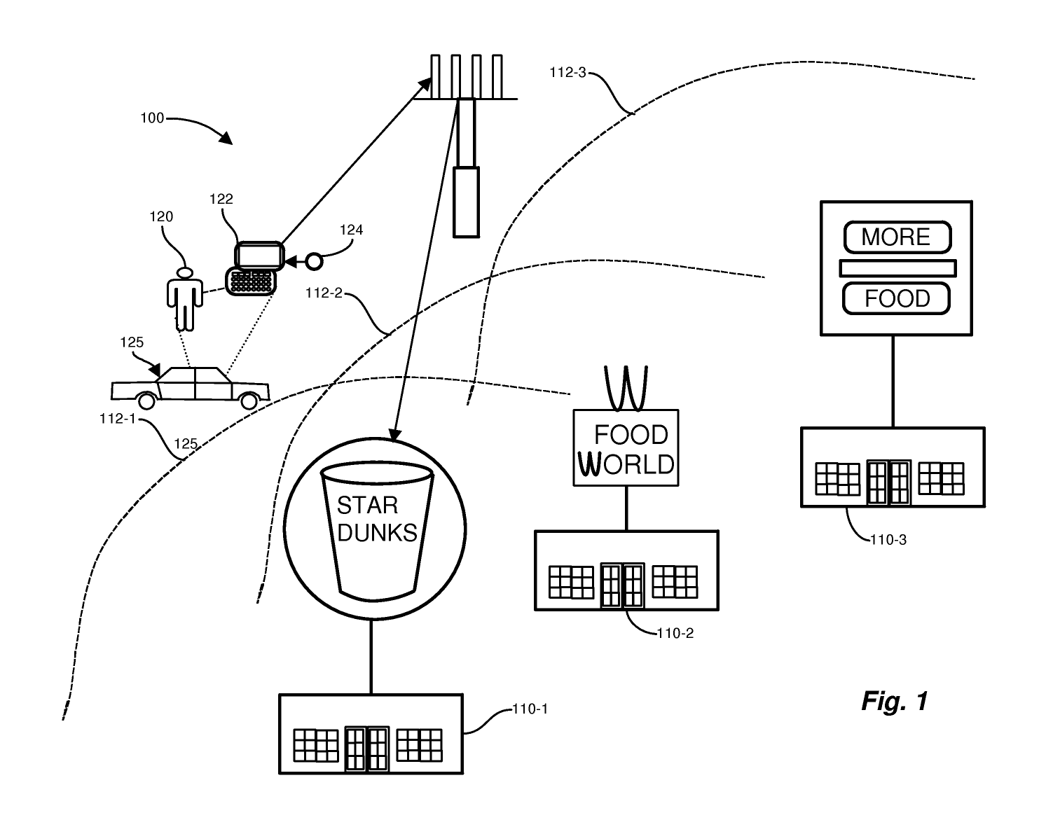

FIG. 1 shows a services environment suitable for use with configurations herein. Referring to FIG. 1, a services environment 100 includes a plurality of merchants 110-1 . . . 110-3 (110 generally) for providing services such as food, beverage and snack items, for example. Merchants 110 often represent POS (point of sale) sites of national vendors having multiple locations. A mobile customer 120 has a personal electronic device 122 (mobile device) such as a cellphone, smartphone or similar device, and travels in the environment of the merchants 110 through either ambulatory or vehicular 125 means, depending on the environment (urban or suburban). Many personal electronic devices have GPS (Global Positioning System) or other location sensing capabilities, and employ such a capability for determining the user 120 location relative to street addresses. However, as GPS capability provides an absolute location reference, a GPS generated location may be referenced to another GPS location for identifying proximity (i.e. distance and direction).

A mobile application 124 (one of so called “apps”) is operable on the mobile device 122 for determining proximity to a merchant 110 based on a predetermined distance defining a proximity boundary 112-1 . . . 112-3 (112 generally) to a particular merchant 110-N. The application 122 sends a location, such as GPS coordinates, for comparison with registered merchants 110 for determining when the user 120 is within the predetermined distance 112, such as a radius or directional indication. Alternatively, the mobile device 122 compares stored locations of registered merchants and compares locations at the device to identify proximity.

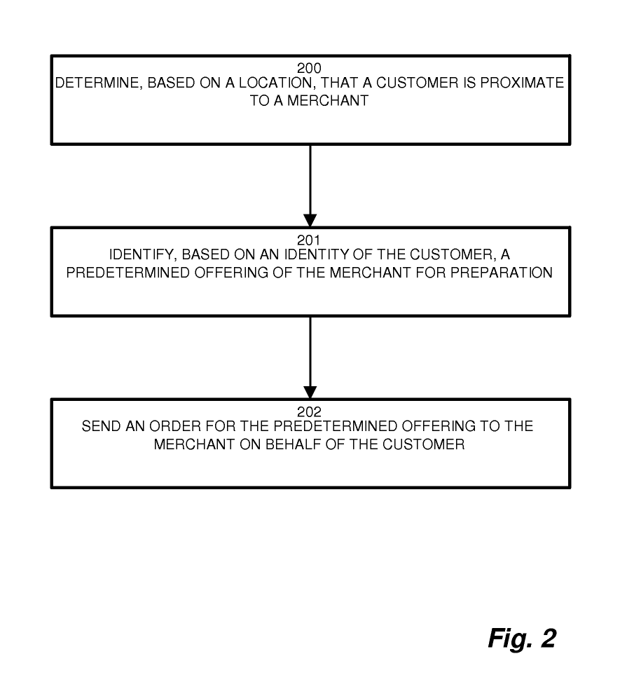

FIG. 2 is a flowchart of service ordering in the environment of FIG. 1. In the general configuration, the disclosed method for ordering services includes, at step 200, determining, based on a location, that a customer 120 is proximate to a merchant 110, and identifying, based on an identity of the customer 120, a predetermined offering of the merchant 110 for preparation and delivery (receipt) by the customer, as depicted at step 201. The predetermined offering may be any goods, services, or combination typically exchanged via counter or drive through manner; some common examples are coffee, bagels, donuts, soft drinks, burgers, etc. Such exchanges often entail a combination of goods and services, and as such, lead time to prepare the order is beneficial. An order for the predetermined offering is then sent to the merchant 110 on behalf of the customer 120, as disclosed at step 202. In the example arrangement, proximity is determined by a GPS enabled cellphone or other personal electronic device 122, and ordering occurs via an intermediary, such as a clearinghouse or order server, discussed further below.

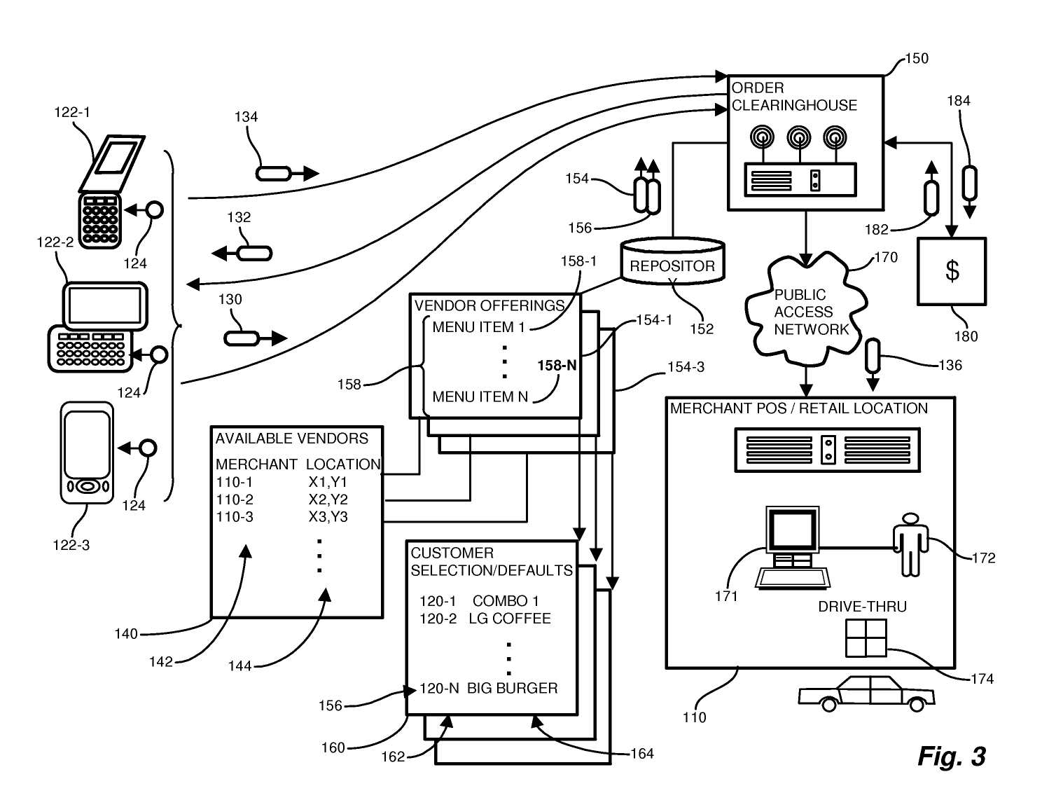

FIG. 3 is a block diagram of the ordering sequence as in FIG. 2. Referring to FIGS. 1-3, a user 120 employs a device 122 such as a cellphone, 122-1, smartphone 122-2 or PDA/tablet/laptop 122-3 or similar mobile device. The device 122 is adapted to launch a proximity ordering application 124 for performing proximity determination and order confirmation. The device 122 periodically transmits proximity indications 130 to an order clearinghouse 150 having a repository 152 of merchants registered for proximity ordering, and the corresponding menus 154-1 . . . 154-3 (154 generally) of predetermined offerings available. The repository 152 maintains a vendor list 140 of available merchant 110 sites 142, as well as the location 144 in GPS coordinates or other suitable identifier. The repository 152 includes, for each vendor or merchant, vendor offerings 154-1 . . . 154-N including a menu (list) of the available predetermined offerings 158 for that particular merchant 110. All merchants (individual locations) of a particular vendor may have the same menu 158, or they may be site specific. A set 160 of preferred predetermined offerings 164 by customer 162 is maintained for each merchant site 154-N.

Upon crossing into a proximity region of a merchant defined by a proximity boundary 112, the order clearinghouse 150 identifies the proximate merchant 110-N, and retrieves, based on the user, a stored menu 154 of predetermined offerings and a default selection 156 previously set by the user. The clearinghouse 150 sends a confirmation request 132 to ask the user if they would like their default selection 156, would like to order a different selection from the available predetermined offerings 158 of the merchant 110-N, or decline to order at this time. For confirmation of the default or modified predetermined offering results in the application 124 sending a confirmed order 134 to the clearinghouse 150, which results in the clearinghouse 150 sending a corresponding order request 136 to the merchant location by a public access network such as the Internet 170 or other suitable communication path.

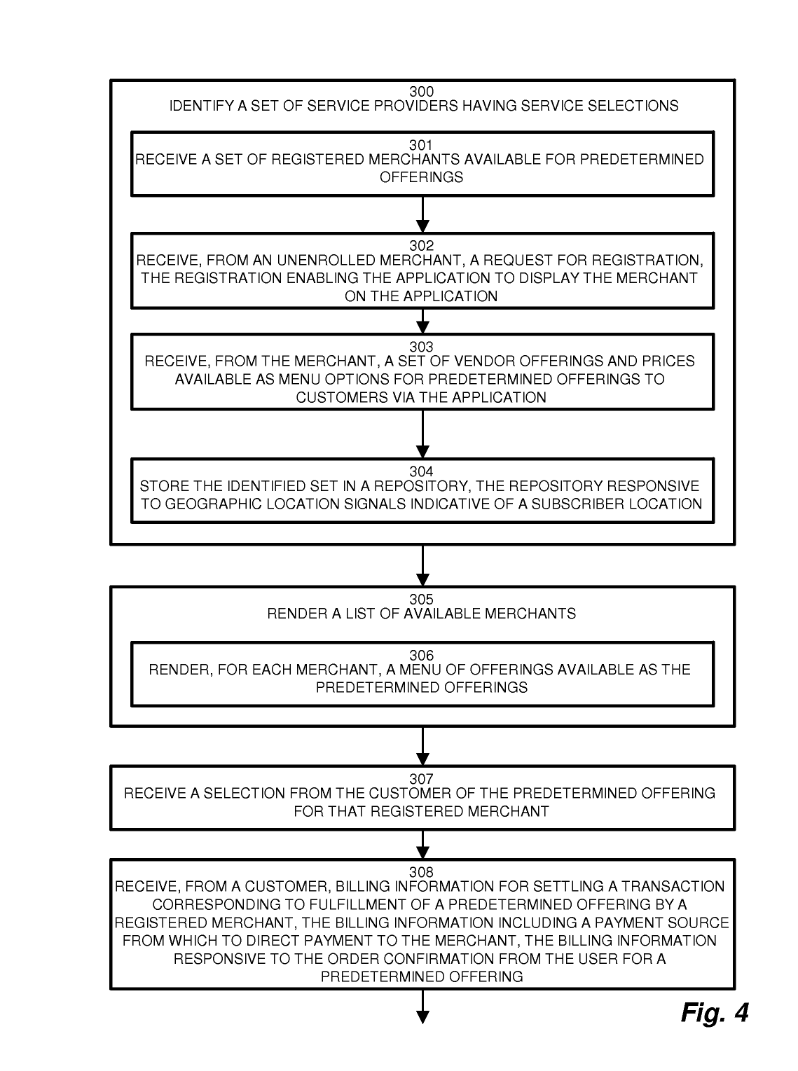

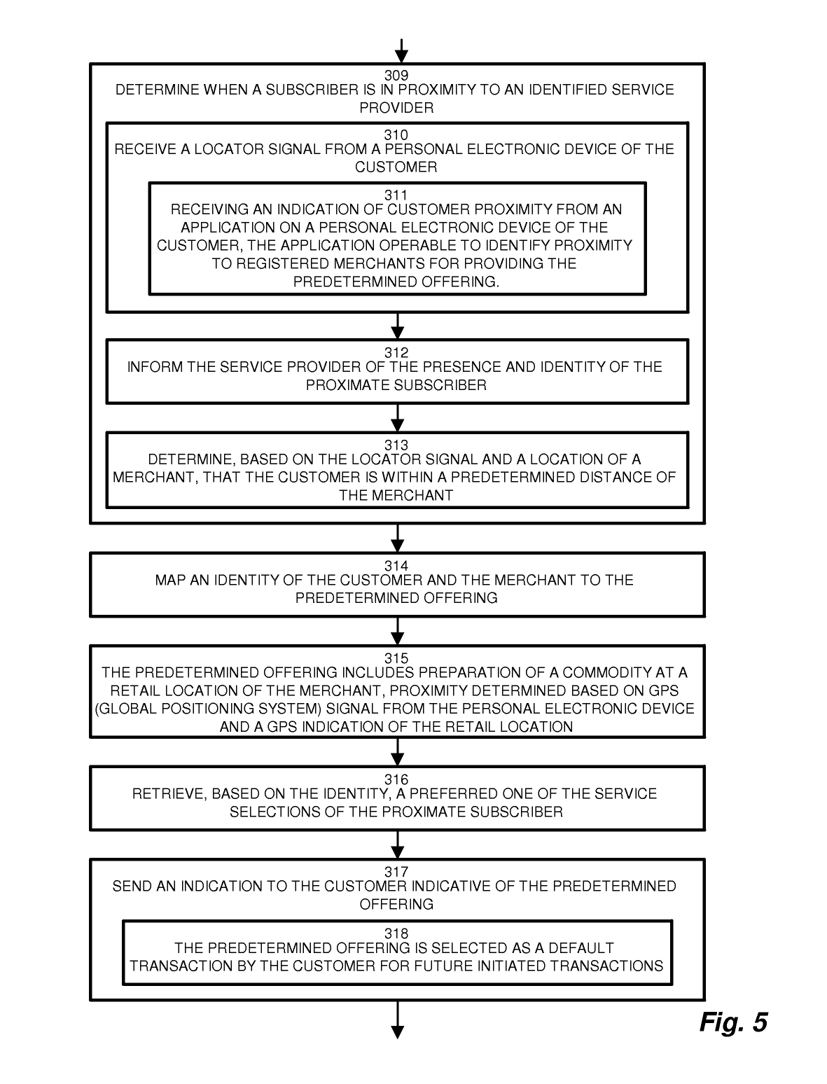

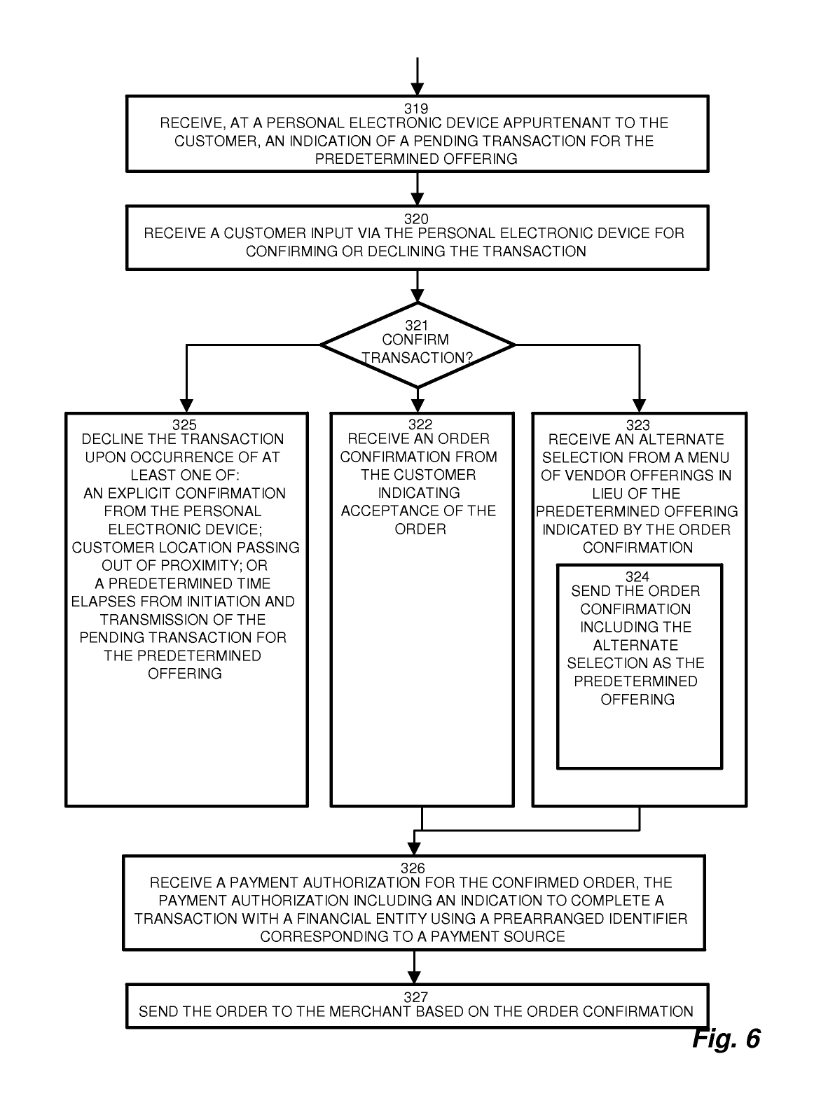

FIGS. 4-6 are a flowchart of the ordering sequence of FIG. 3. Referring to FIGS. 1 and 3-6, the method for providing services responsive to proximity of a customer 120 to the service provider (merchant) 110 as disclosed herein includes, at step 300, identifying a set of service providers 110-N having service selections 154, and receiving a set of registered merchants 140 available for predetermined offerings 158, as depicted at step 301. Prior to fulfilling customer orders, a base of merchants responsive to the automated ordering is developed by the order clearinghouse. Merchants/vendors would view the incentive of increased customer traffic as a reason to register/enroll with the clearinghouse 150. The clearinghouse 150 or other central facilitator receives, from an unenrolled merchant, a request for registration, such that the registration enables the application 124 to display the merchant 110 on the application from a user device 122, as depicted at step 302. The clearinghouse 150 also receives, from the merchant 110, a set of vendor offerings 154 and prices available as menu options 158 for predetermined offerings to customers via the application 124, as shown at step 303. The clearinghouse 150 maintains a repository 152 for storing the identified set 154 in the repository 152, such that the repository 152 is responsive via the clearinghouse to geographic location signals 130 indicative of a subscriber 120 location, as shown at step 304. The clearinghouse 150 operates as a central register of merchants 110 and receives the proximity indicators 130 from subscribed customers 120, such as by periodic polling. The clearinghouse 150 may be distributed across multiple sites in any suitable manner as GPS and transport capabilities deem, such as by national, regional, or local operation.

A customer 120 can enroll with particular merchants by invoking the user device to render a list 140 of available merchants 110, as depicted at step 305. The application 124 renders, for each merchant 110, a menu 154 of offerings 158 available as the predetermined offerings, as disclosed at step 306, and receives a selection from the customer 120 of the predetermined offering for that registered merchant 110 to tag as the default predetermined offering, as depicted at step 307. Upon crossing the proximity threshold 112 for a merchant 110 with whom the customer 120 has enrolled, the default predetermined offering 156 is proposed in the confirmation request 132, and may be confirmed, declined, or modified via the application 124.

During enrollment, the clearinghouse 150 also receives, from a customer 120, billing information for settling a transaction corresponding to fulfillment of a predetermined offering 158-N by a registered merchant 110, such that the billing information includes a payment source, typically a bank account or credit card number, from which to direct payment to the merchant 110, in which the billing information is responsive to the order confirmation 134 from the user for a predetermined offering 158-N, as shown at step 308.

Upon customer 120 enrollment and merchant 110 registration, the customer becomes a subscriber of the clearinghouse 150, such that a user device 122 passing a proximity threshold 112 triggers the proximity indication 130 from the user device 122 to the clearinghouse 150. The proximity indication 130, in the example configuration, may be GPS coordinates sent periodically to the clearinghouse 150 from the user device 122 for computation and comparison with the location 144 of registered merchants. Alternatively, the user device 122 may have merchant location information stored and compute proximity, such that the proximity indication 130 denotes proximity to the merchant 110 and merely requests the confirmation request 132 with the default predetermined offering. In either scenario, the clearinghouse 150 determines when a subscriber/customer 120 is in proximity to an identified service provider registered as a merchant 110, as depicted at step 309.

At the clearinghouse 150, the locator signal is received as a proximity indication 130 from the personal electronic device 122 of the customer 120, as depicted at step 310. In particular arrangements, the clearinghouse 150 receives the indication of customer proximity from the application 124 on the personal electronic device 122 of the customer 120, in which the application is operable to identify proximity to registered merchants for providing the predetermined offering 158, as depicted at step 311. Otherwise, proximity may be determined by the clearinghouse 150 via a comparison of GPS reported locations.

The clearinghouse 150 or user device 122 informs the service provider 110 of the presence and identity of the proximate subscriber 120, as shown at step 312, and the merchant 110 determines, based on the locator signal 130 and a location of a merchant, that the customer 120 is within a predetermined distance 112 of the merchant 110, disclosed at step 313.

The clearinghouse 150 maps an identity of the customer 120 and the merchant 110 to the predetermined offering 158, using table 160 or a modified confirmed order 134, as shown at step 314. In the example arrangement, the predetermined offering 158 includes preparation of a commodity at a retail location of the merchant, in which proximity is determined based on GPS (Global Positioning System) signal from the personal electronic device 120 and a GPS indication of the retail location 110-N. However other services by other vendors may be performed, such as oil change services, prescriptions, dry cleaning, grocery orders, and other such services where lead time is mitigated by advance notice of customer proximity and impending arrival.

The clearinghouse 150 retrieves, based on the identity, a preferred one of the service selections 158 of the proximate subscriber 120 from the customer selection defaults 160, as shown at step 316. The clearinghouse sends an indication 132 to the customer 120 indicative of the predetermined offering 158 found as the default selection 164, as depicted at step 317. Typically, the predetermined offering 158 is selected as a default transaction 156 by the customer for future initiated transactions, as shown at step 318, and may be modified via the application 124.

Upon receipt of the proximity indication 130 and determination of the default predetermined offering 164, the customer 120 receives, at the personal electronic device 122 appurtenant to the customer 120, an indication of a pending transaction 132 for the predetermined offering, as shown at step 319. The application 124 displays the pending transaction to the customer 120, and receives a customer input via the personal electronic device 122 for confirming or declining the transaction, as shown at step 320. The application 124 allows multiple customer selections, as shown at step 321. The customer may confirm the default predetermined offering (“the usual”), in which case the clearinghouse 150 receives an order confirmation 134 from the customer indicating acceptance of the order, as shown at step 322, or may receive an alternate selection from the menu 154 of vendor offerings 158 in lieu of the predetermined offering indicated by the order confirmation request, ad shown at step 323. The application 124 displays a corresponding menu 154 depending on the vendor/merchant, and sends the order confirmation 134 including the alternate selection as the predetermined offering 156, as depicted at step 324. Alternatively, the customer may decline the purchase at the present time. The transaction may be declined upon occurrence of either an explicit confirmation from the personal electronic device 122 via the application 124, by the customer 120 location passing out of proximity (i.e. customer drives past the merchant 110 and continues), or if a predetermined time elapses from initiation and transmission of the pending transaction for the predetermined offering, as disclosed at step 325.

If the customer elects to confirm the default or modified order, then the clearinghouse 150 receives a payment authorization 184 for the confirmed order 134, in which the payment authorization includes an indication to complete a transaction with a financial entity 180 using a prearranged identifier 182 corresponding to a payment source. The prearranged identifier 182 may be any suitable token or payment method commonly used for online purchases, such as a credit card number, bank account number, online service (i.e. PayPal® identifier) or other mechanism. The clearinghouse 150 then sends the order 136 to the merchant 110 based on the order confirmation 134 for receipt on a telecommunication device 171 (i.e. PC, vendor remote order screen, cellphone) preparation by the vendor staff 172 and delivery at either a counter or drive-up window 174 upon customer 120 arrival. A final sale acknowledgment by the merchant confirms delivery and indicates to the payment service that the payment authorization 184 terms have been fulfilled by the merchant (i.e. product has been received by the customer). Clearinghouse reports to each merchant or vendor may also be provided and applied to customer loyalty entries to be applied on the customer's behalf.

Other enhancements in various configurations include the following.

In addition to traditional concepts such as “buy 9 (“widgets”) get tenth free” you can have “buy four (“widgets”) in a set time period, i.e. one month, and get a fifth free. Such customer loyalty statistics may be gathered by the clearinghouse and combined with the vendor/merchant internal record of in-person purchases to obtain a complete aggregation of customer purchases made by either medium for calculating loyalty rewards.

When installing application on device such as a Smartphone or Tablet in which a user has contacts stored, the option “recommend to friend” will be available. If any contacts receive a recommendation (i.e. through a text with a link) and install the app, the person who sent the recommendation gets a free “widget” (i.e. coffee) when the first purchase is made by the individual who recommended it. Whenever a customer has a reward available, a notification would show up informing them. Even rewards based upon future sales to those who accepted referrals are possible. This is an ideal way for a business to build “brand ambassadors” with strong loyalty too, and identification with, the brand. Various other apps may be envisioned.

The disclosed arrangement provides comprehensive customer data acquisition through use of unprecedented customer data sets. Including complete demographic and physical address details of customers. As well as favorite purchases, frequency of visits, locations visited, which reward programs work best, etc. Information on automated purchases generated as defined herein may be combined with the vendors internal records of regular customers to coalesce purchases made by either mechanism and aggregate the purchases toward customer loyalty programs.

Risk reduction is enhanced by reducing cash transactions in the business. Employee error and theft opportunities are reduced as well as offering reduced risk of criminal targeting.

Other customer (subscriber) advantages include the following, as mentioned above:

1. Quick service.

2. Hassle free service. (No order placement through a squawk box, or payment transaction work).

3. No need to carry money/rewards cards.

4. Personalized experience, a friendly greeting by name.

5. A customized rewards experience tailored to customer preferences and history.

An alternate arrangement provides a method for connecting service providers with proximate subscribers by identifying a set if service providers having a fee arrangement for inclusion in a services provider database, and storing, for each service provider, a set of offered services. A mobile device app or similar GUI allows storing, for each subscriber, a personal service selection, and the service provider is alerted to provide, when a subscriber is detected proximate to a service provider site, the stored personal service selection, the proximity computed from a comparison of GPS coordinates of the service provider site and GPS coordinates of a computer module appurtenant to the subscriber.

It will be appreciated by those skilled in the art that alternate configurations of the disclosed invention include a multiprogramming or multiprocessing computerized device such as a workstation, handheld or laptop computer or dedicated computing device or the like configured with software and/or circuitry (e.g., a processor as summarized above) to process any or all of the method operations disclosed herein as embodiments of the invention. Still other embodiments of the invention include software programs such as a Java Virtual Machine and/or an operating system that can operate alone or in conjunction with each other with a multiprocessing computerized device to perform the method embodiment steps and operations summarized above and disclosed in detail below. One such embodiment comprises a computer program product that has a computer-readable storage medium including computer program logic encoded thereon that, when performed in a multiprocessing computerized device having a coupling of a memory and a processor, programs the processor to perform the operations disclosed herein as embodiments of the invention to carry out data access requests. Such arrangements of the invention are typically provided as software, code and/or other data (e.g., data structures) arranged or encoded on a non-transitory computer readable storage medium such as an optical medium (e.g., CD-ROM), floppy or hard disk or other medium such as firmware or microcode in one or more ROM, RAM or PROM chips, field programmable gate arrays (FPGAs) or as an Application Specific Integrated Circuit (ASIC). The software or firmware or other such configurations can be installed onto the computerized device (e.g., during operating system execution or during environment installation) to cause the computerized device to perform the techniques explained herein as embodiments of the invention.

What is claimed is:

1. A method for ordering services comprising:
determining, based on a location, that a customer is proximate to a merchant;
identifying, based on an identity of the customer, a predetermined offering of the merchant for preparation; and
sending an order for the predetermined offering to the merchant on behalf of the customer.

2. The method of claim 1 further comprising:
sending an indication to the customer indicative of the predetermined offering;
receiving an order confirmation from the customer indicating acceptance of the order; and
sending the order to the merchant based on the order confirmation.

3. The method of claim 2 wherein confirming further comprises:
receiving an alternate selection from a menu of vendor offerings in lieu of the predetermined offering indicated by the order confirmation, and
sending the order confirmation including the alternate selection as the predetermined offering.

4. The method of claim 2 further comprising receiving a payment authorization for the confirmed order, the payment authorization including an indication to complete a transaction with a financial entity using a prearranged identifier corresponding to a payment source.

5. The method of claim 1 further comprising:
receiving, at a personal electronic device appurtenant to the customer, an indication of a pending transaction for the predetermined offering; and
receiving a customer input via the personal electronic device for confirming or declining the transaction.

6. The method of claim 1 further comprising:
receiving a locator signal from a personal electronic device of the customer;
determining, based on the locator signal and a location of a merchant, that the customer is within a predetermined distance of the merchant; and
mapping an identity of the customer and the merchant to the predetermined offering.

7. The method of claim 2 further comprising:
declining the transaction upon occurrence of at least one of:
an explicit confirmation from the personal electronic device;
customer location passing out of proximity; or
a predetermined time elapses from initiation and transmission of the pending transaction for the predetermined offering.

8. The method of claim 1 further comprising selecting the predetermined offering as a default transaction by the customer for future initiated transactions; and
aggregating the transactions over time for coalescing purchases from a particular customer for customer loyalty tracking.

9. The method of claim 1 further comprising:
receiving an indication of customer proximity from an application on a personal electronic device of the customer, the application operable to identify proximity to registered merchants for providing the predetermined offering.

10. The method of claim 9 wherein the application is responsive to:
receiving a set of registered merchants available for predetermined offerings;
rendering a list of available merchants;
rendering, for each merchant, a menu of offerings available as the predetermined offerings; and
receiving a selection from the customer of the predetermined offering for that registered merchant.

11. The method of claim 5 wherein predetermined offering includes preparation of a commodity at a retail location of the merchant, proximity determined based on GPS (Global Positioning System) signal from the personal electronic device and a GPS indication of the retail location.

12. The method of claim 1 further comprising receiving, from a customer, billing information for settling a transaction corresponding to fulfillment of a predetermined offering by a registered merchant, the billing information including a payment source from which to direct payment to the merchant, the billing information responsive to the order confirmation from the user for a predetermined offering.

13. The method of claim 1 further comprising:
receiving, from an unenrolled merchant, a request for registration, the registration enabling the application to display the merchant on the application; and
receiving, from the merchant, a set of vendor offerings and prices available as menu options for predetermined offerings to customers via the application.

14. A personal electronic device having an application for associating merchants with customers based on proximity of the customer to the merchant, the device comprising
an application for ordering services configured to:
determine, based on a location, that a customer is proximate to a merchant;
identify, based on an identity of the customer, a predetermined offering of the merchant for preparation; and
send an order for the predetermined offering to the merchant on behalf of the customer.
receive an indication indicative of the predetermined offering; and
send an order confirmation indicating acceptance of the order, the confirmed orders for receipt by a responsive merchant.

15. The device of claim 14 wherein the personal electronic device further includes:
a remote application for establishing an association between the customer and the merchant, the association for initiating an automated transaction for a predetermined offering; and
a locator for identifying the location of the personal electronic device relative to the merchant.

16. A computer program product having encoded instructions stored on a non-transitory computer readable storage medium for performing a method of providing services responsive to proximity of a customer to the service provider, the method comprising:
identifying a set of service providers having service selections;
storing the identified set in a repository, the repository responsive to geographic location signals indicative of a subscriber location;
determining when a subscriber is in proximity to an identified service provider;
informing the service provider of the presence and identity of the proximate subscriber; and
retrieving, based on the identity, a preferred one of the service selections of the proximate subscriber.

17. The method of claim 16 wherein determining further comprises determining when a computing module of a subscriber is in proximity to a service provider responsive to a geographic location.

18. The method of claim 17 wherein the geographic location signals are generated by a Global Positioning System (GPS) responsive device and the computing module is a mobile personal computing device responsive to wireless signals for Internet connectivity.

19. The method of claim 18 further comprising invoking a Graphical User Interface (GUI) of the computing module for storing, associated with the subscriber, a preferred service selection of the service provider.

20. The method of claim 17 wherein proximity is determined by the computing module of the subscriber being disposed within a predetermined distance from a mobile service provisioning station.
